(19) United States
(12) Patent Application Publication
(10) Pub. No.: US 2017/0064935 A1
(43) Pub. Date: Mar. 9, 2017

(54) RECIPROCATING ICE CUTTING SYSTEM FOR OPEN WATER

(71) Applicant: Allen Matthew Huju, Bigfork, MN (US)

(72) Inventor: Allen Matthew Huju, Bigfork, MN (US)

(21) Appl. No.: 14/847,267

(22) Filed: Sep. 8, 2015

(51) Int. Cl. A01K 97/01; B23D 49/11; E21B 7/00

(52) U.S. Cl. CPC A01K 97/01; E21B 7/008; B23D 49/11

(57) ABSTRACT

An ice cutting apparatus is structured to have at least:
a two-hand gripping handle;
a motor in drive communication with a circular drive gear;
the circular drive gear;
a reciprocating geared lever configured to be driven by the circular drive gear; and
a serrated blade engaged with the reciprocating geared lever, the serrated blade configured to reciprocate as the circular drive gear rotates.

### BACKGROUND OF THE INVENTION

1. Field of the Invention

The present invention relates to the field of cutting devices having a saw blade, and particularly to manually-controlled, motor-driven ice-cutting apparatus.

1. 2. Background of the Art

The cutting of ice for structural and convenience purposes has been performed by human beings for centuries. Ice has been used for structural purposes in cold climates and cutting into ice has enabled access by human predators to game, such as fish, during the coldest of weather over lakes and ponds.

Ice can be extremely hard and cutting the ice by hand can be time consuming and difficult (and dangerous). Earliest efforts used serrated blades and expanded to serrated saws to cut through the ice. Later efforts, primarily to initiate cutting into ice or to create an ice-fishing hole were accomplished first by manually-powered augers and then motor driven augers. Blocks of ice were often shaped by lathes. Chain saws have often been used to cut through ice after a hole has been opened. These can be dangerous methods of cutting through ice, especially lake ice, as the blades are often exposed above the ice and can come into contact with users.

Numerous devices have been proposed and used for these various techniques.

U.S. Pat. No. 4,208,977 Jahns describes a water navigable vessel having an ice-breaking bow and a rotatable screw mounted on the front on the bow for the purpose of advancing the vessel up onto an ice layer and failing the ice layer in flexural bending. The rotatable screw includes ice-cutting blades which form grooves within the top of said ice layer thus translating the rotational energy of said screw into a generally horizontal, (longitudinal) tractional force which pulls or drags the bow of said vessel forward and over said ice layer and, thereby, utilizes the mass of said bow to impart a downward gravitational force upon said layer of ice to cause it to fail flexurally.

U.S. Pat. No. 5,189,939 (Allen) describes an apparatus for cutting blocks of ice has a frame which defines a feed chute slightly larger than the uncut block of ice. Four saws are mounted to the frame in pairs. Each pair of saws includes two counter rotating, radial saw blades aligned opposite each other and extending toward one another into the feed chute of the frame. To facilitate the transfer of the uncut block of ice into the feed chute, a feed assembly is attached to the frame. A discharge assembly is secured to the frame to assist in removing the cut ice from the frame. The frame is mounted on a stand in an inclined position with the feed assembly higher than the discharge assembly to allow gravity feed of the ice. A gang of blades may be used with the saws in order to cut the block of ice into smaller sized blocks with one pass through the feed chute. The saw blades have carbide-tipped saw teeth to extend the amount of use between resharpening or replacement. Cutouts are formed in the saw blades to compensate for extreme temperature changes by allowing the saw blades to expand and contract without warping.

U.S. Pat. No. 5,950,738 (Caswell) describes using a standard ice auger having a central shaft, a spiral fighting affixed thereon, and an ice cutting blade at the lower end of the flighting, a cylindrical ice hole is bored through an ice sheet. The inventive apparatus, mounted adjacent a lower portion of the standard ice auger, is then used to form an inverted funnel-shaped area at the lower end of the cylindrical ice hole. The inventive apparatus includes a bracket mounted to the ice auger and an ice hole flaring blade pivotally mounted to the bracket. A spring biases the ice hole flaring blade toward a transport position wherein the blade has its free end extending toward an upper end of the ice auger. The ice hole flaring blade is pivotable to an operable position wherein the blade is aligned generally below the ice cutting blade of the auger and has its free end extending downwardly and outwardly from the central shaft of the ice auger. In this operable position, the ice hole flaring blade is aligned to cut an angled cone-shaped face at the bottom edge of the previously formed cylindrical ice hole.

Other disclosed ice-cutting systems (primarily augers) are described in U.S. Pat. Nos. (8,397,835; 7,946,355; 7,641,001; 7,140,456; 6,681,871; 5,950,738; 5,330,014; 5,190,113; 4,971,161; 4,862,591; and 4,488,605.

### SUMMARY OF THE INVENTION

An ice cutting apparatus is structured to have at least:
a two-hand gripping handle;
a motor in drive communication with a circular drive gear;
the circular drive gear;
a reciprocating geared lever configured to be driven by the circular drive gear; and
a serrated blade engaged with the reciprocating geared lever, the serrated blade configured to reciprocate as the circular drive gear rotates.

### BRIEF DESCRIPTION OF THE FIGURES

FIG. 1 is a first perspective view of an ice-cutting device according to the present technology.

FIG. 2 is a second perspective view of an ice-cutting device according to the present technology indicating a possible position for the motor and handles.

FIG. 3 is a side view of an ice-cutting device according to the present technology.

### DETAILED DESCRIPTION OF THE INVENTION

An ice cutting apparatus is structured to have at least:
a two-hand gripping handle;
   e gear (e.g., as shown in the figures or a worm gear);
the circular drive gear;
a reciprocating geared lever configured to be driven by the circular drive gear; and
a serrated blade engaged with the reciprocating geared lever, the serrated blade configured to reciprocate as the circular drive gear rotates.

The ice-cutting apparatus may have a top plate is positioned over the circular drive gear, and the two-hand gripping handle is attached to the top plate, and the motor may be positioned over the top plate and the circular drive gear. Side plates may extend below the circular drive gear to cover at least a portion of the serrated blade.

The base plate may be connected to the side plates to provide an opening through which the serrated blade extends and retracts during reciprocation of the blade when driven by the circular drive gear. The base plate acts as a guide plate, with the serrated blade tip preferably extending at least to or past a lowermost side of the base plate so that the blade tip is unlikely to catch on the hole or slot when the tip of the blade is in its most retracted position and then moves towards its most extended position. Similar slits are found in base plates in jig saws and rotary saws/

The ice-cutting apparatus may have the circular drive gear in communication with the serrated blade first through a linkage arm engaged with the circular drive gear, the linkage arm then engaged with a slide arm, and the slide arm then engaged with the serrated blade. The upper end of the linkage arm is engaged eccentrically with the circular gear drive so that when the connection (rotating) point between the circular drive gear and the linkage arm are at a lowest point in the rotation of the circular gear drive, the tip of the serrated blade is fully extended. When the connection (rotating) point between the circular drive gear and the linkage arm are at a highest point in the rotation of the circular gear drive, the tip of the serrated blade is fully retracted. By this configuration, the ice-cutting apparatus has the circular motion of the circular drive gear is configured to create a reciprocating motion in the linkage arm, and the linkage arm is configured to create a linear reciprocating motion in the slide arm. The ice-cutting apparatus may have side plates extend below the circular drive gear to cover at least a portion of the serrated blade.

The ice-cutting apparatus base plate may be connected to the side plates to provide an opening through which the serrated blade extends and retracts during reciprocation of the blade when driven by the circular drive gear. The base plate may be supported on the ice-cutting apparatus by hinges, allowing the base plate to maintain a planar conformation to ice being cut while the ice-cutting apparatus shifts its angular orientation towards the ice being cut, shifting a cutting angle of the reciprocating serrated blade against the ice.

A method according to the present technology cuts ice on a surface of a frozen body of water with the ice-cutting apparatus described herein. It can be done by positioning the serrated blade against or into the ice on the surface of the frozen body of water, running the motor to cause the serrated blade to contact and cut the ice while it remains on the surface of the frozen body of water.

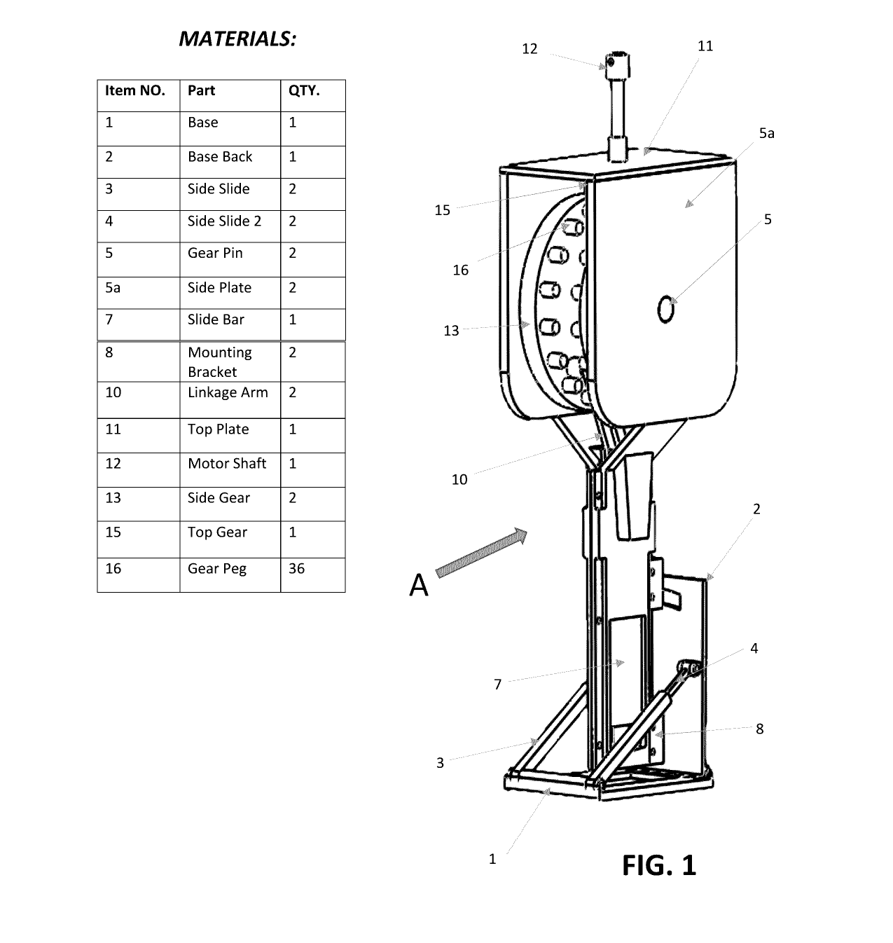

FIG. 1 is a first perspective view of an ice-cutting device A according to the present technology. The device A shows a base plate 1, base back 2, and side slides 3, and piston side slide 4. The piston side slide 4 is attached to the base back 2 by a rotating hinge 14. By having the piston side slide 4 extend when the base back 2 freely bends relative to the base 1, the piston side slide 4 extends away from the side slide 3 and the rotating hinge allows the extension without undue stress on piston slide 4. The motor shaft 12 (without the motor shown) is attached through the top plate 11. The circular gear drive 13 is shown with gear pins 16, linkage arm 10 and side 5 with an end of the circular gear drive axis 5a shown. The slide bar 7 is also shown.

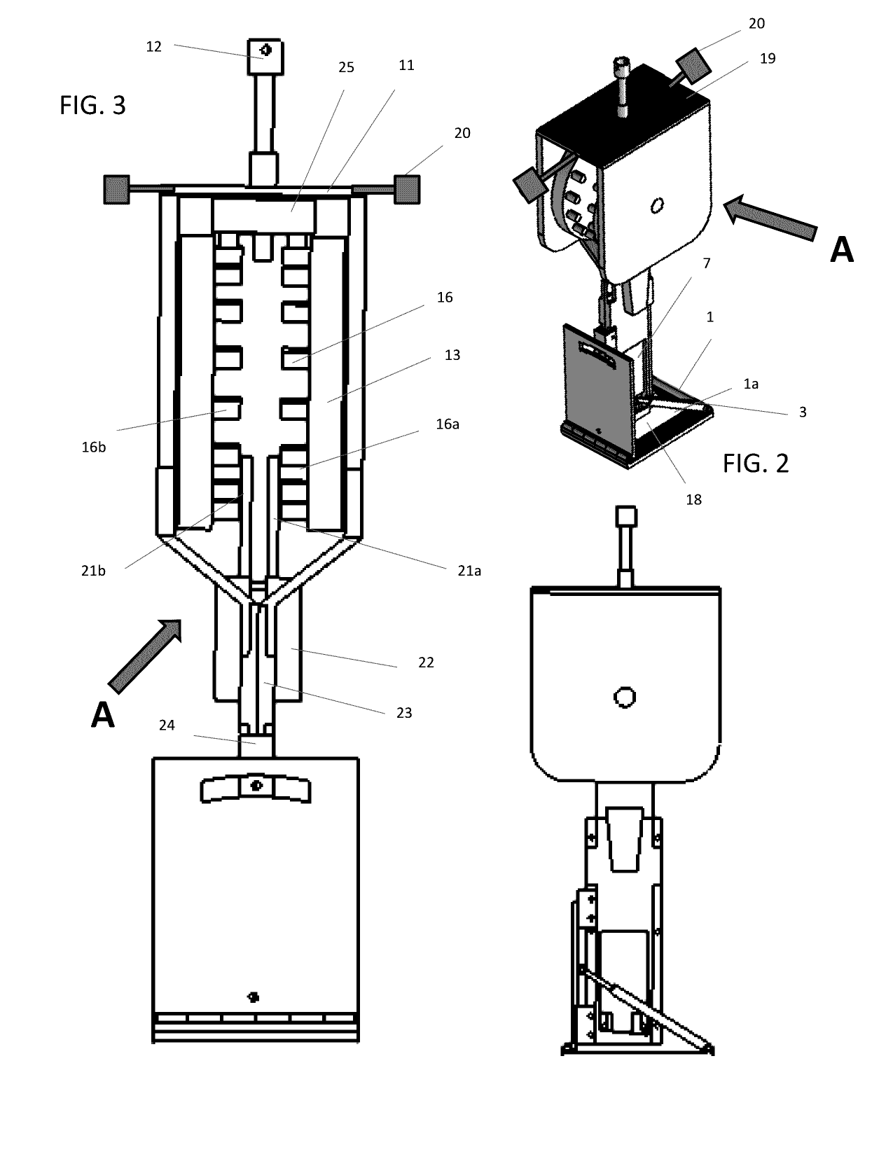

FIG. 2 is a second perspective view of an ice-cutting device A according to the present technology indicating a possible position for the motor 19 and handles 20.

A serrated blade 20 is shown extending from the slide bar 7. The opening 1a in the base 1 is also shown.

FIG. 3 is a side view of an ice-cutting device A according to the present technology. The motor shaft 12 attached through the top plate 11 with the top drive gear 25 driving the circular gear drive 13 and pins 16. Pins 16a and 16b are shown attached to linkage arms 21a and 21b driving side slide 22 carrying blade support 23 with a space 24 where the blade (not shown) would be secured.

The motor may be any powered system, electric, combustion, hydraulic or the like.

Operation of FIG. 1

The shaft 12 that attaches to the engine (not shown) of the ice-cutting device (e.g., with a pin) then turns the shaft horizontally (in a rotating manner). The top gear (which may be beveled) may be mounted directly to the shaft and also turn horizontally. Two side gears (the circular drive gears, which also may be beveled) are then turned in a vertical motion from the small gear. The two side gears turning cause the two linkage arms to move in a (train drive fashion) reciprocating up and down direction. The linkage arms are attached to the slide arm that slides in a more linear vertical motion. This slide arm is the part that is attached to the blade and causes the blade to make a sawing motion. The tilting system (between the base and base back) is based on two parts; the side tilt and the front tilt.

The side tilt work by one pin being mounted in one spot and the other pin is able to slide freely in the slot based on the motion the operator performs (allows for the machine to tip left to right 20 degrees).

The front tilt, is based on the two slide arms and a hinge which allows the machine to move front and back from the push or pull of the operator.

In one other embodiment, this device may also be a combination of an ice auger engine, a hand ice saw, with the concept of a reciprocating saw. This device is not normally constructed with an engine attached to it but can be if desired. This is more or less is an attachment to an existing auger engine. The attachment will attach to the engine the same way a normal auger would (pin). To transfer the circular motion of the engine into a linear motion of the blade there will be a worm gear box making this conversion. The gear will have to be roughly 8 inches in diameter causing the linkage between the worm gear and the blade to travel a linear path of approximately 8 inches. Attached to the gear box will be a guard that will work as that of one on a reciprocating saw. This will allow the device to press against the ice and the saw to do the work. The guard will have a slide tilt allowing the device to tilt 20 degrees in either direction (left or right). The blade will be attached to the linkage arm, with two bolts, the linkage arm will then be hooked to the worm gear. The blade will be constructed with 7 angled “teeth” that cut on the upwards stroke of the linear blade. The angle on the teeth compared to the blade allow it to cut more ice relative to the width of the blade. The entire device will be constructed out steal with a rust proof paint keeping it durable in the weather. The end product will be used for cutting clean spear holes for winter spearing allowing the fisher man to cut angles and easily cutting the holes

What is claimed:

1) An ice cutting apparatus comprising:
A two-hand gripping handle;
A motor in drive communication with a circular drive gear;
The circular drive gear;
A reciprocating geared lever configured to be driven by the circular drive gear; and
A serrated blade engaged with the reciprocating geared lever, the serrated blade configured to reciprocate as the circular drive gear rotates.

2) The ice-cutting apparatus of claim 1 wherein a top plate is positioned over the circular drive gear, and the two-hand gripping handle is attached to the top plate.

3) The ice-cutting apparatus of claim 2 wherein the motor is positioned over the top plate and the circular drive gear.

4) The ice-cutting apparatus of claim 1 wherein side plates extend below the circular drive gear to cover at least a portion of the serrated blade.

5) The ice-cutting apparatus of claim 4 wherein a base plate is connected to the side plates to provide an opening through which the serrated blade extends and retracts during reciprocation of the blade when driven by the circular drive gear.

6) The ice-cutting apparatus of claim 1 wherein the circular drive gear is in communication with the serrated blade first through a linkage arm engaged with the circular drive gear, the linkage arm then engaged with a slide arm, and the slide arm then engaged with the serrated blade.

7) The ice-cutting apparatus of claim 6 wherein circular motion of the circular drive gear is configured to create a reciprocating motion in the linkage arm, and the linkage arm is configured to create a linear reciprocating motion in the slide arm,

8) The ice-cutting apparatus of claim 7 wherein side plates extend below the circular drive gear to cover at least a portion of the serrated blade.

9) The ice-cutting apparatus of claim 8 wherein a base plate is connected to the side plates to provide an opening through which the serrated blade extends and retracts during reciprocation of the blade when driven by the circular drive gear.

10) The ice-cutting apparatus of claim 5 wherein the base plate is supported on the ice-cutting apparatus by hinges, allowing the base plate to maintain a planar conformation to ice being cut while the ice-cutting apparatus shifts its angular orientation towards the ice being cut, shifting a cutting angle of the reciprocating serrated blade against the ice.

11) The ice-cutting apparatus of claim 10 wherein the base plate is supported on the ice-cutting apparatus by hinges, allowing the base plate to maintain a planar conformation to ice being cut while the ice-cutting apparatus shifts its angular orientation towards the ice being cut, shifting a cutting angle of the reciprocating serrated blade against the ice.

12) A method of cutting ice on a surface of a frozen body of water with the ice-cutting apparatus of claim 1 comprising positioning the serrated blade against or into the ice on the surface of the frozen body of water, running the motor to cause the serrated blade to contact and cut the ice while it remains on the surface of the frozen body of water.

13) A method of cutting ice on a surface of a frozen body of water with the ice-cutting apparatus of claim 5 comprising positioning base plate against the surface of the frozen body of water, pressing the serrated blade against or into the ice on the surface of the frozen body of water, running the motor to cause the serrated blade to contact and cut the ice while it remains on the surface of the frozen body of water.

14) A method of cutting ice on a surface of a frozen body of water with the ice-cutting apparatus of claim 9 comprising positioning base plate against the surface of the frozen body of water, pressing the serrated blade against or into the ice on the surface of the frozen body of water, running the motor to cause the serrated blade to contact and cut the ice while it remains on the surface of the frozen body of water.

15) A method of cutting ice on a surface of a frozen body of water with the ice-cutting apparatus of claim 10 comprising positioning base plate against the surface of the frozen body of water, pressing the serrated blade against or into the ice on the surface of the frozen body of water, running the motor to cause the serrated blade to contact and cut the ice while it remains on the surface of the frozen body of water.

16) A method of cutting ice on a surface of a frozen body of water with the ice-cutting apparatus of claim 11 comprising positioning base plate against the surface of the frozen body of water, pressing the serrated blade against or into the ice on the surface of the frozen body of water, running the motor to cause the serrated blade to contact and cut the ice while it remains on the surface of the frozen body of water.
